(19) United States
(12) Patent Application Publication
(10) Pub. No.: US 2002/0000533 A1
(43) Pub. Date: Jan. 3, 2002

(54) Hydrophobic metal particles for magnetorheological composition

(76) Inventors: Vardarajan R. Iyengar, Beavercreek, OH (US); Robert Thomas Foister, Rochester Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 09/751,139

(22) Filed: Dec. 29, 2000

Related U.S. Application Data
(60) Provisional application No. 60/173,793, filed on Dec. 30, 1999.

(51) Int. Cl. H01F 1/28

(52) U.S. Cl. 252/62.55; 252/62.52; 252/62.54

(57) ABSTRACT

Hydrophobic metal particles that are useful as the magnetizable particles in magnetorheological fluids and magnetorheological elastomers are provided. Hydrophilic metal particles, such as carbonyl iron particles, are made hydrophobic by reacting a surface hydroxyl on the solid metal particle with a reactive surfactant. Particles are coated with the reactive surfactant to cover at least about 90% of the surface of the particles and then washed with a low viscosity synthetic hydrocarbon to remove any excess surfactant. The particles are stabilized against oxidation and irreversible coagulation during further processing, and formulation and use in magnetorheological fluids and elastomers.

### CROSS-REFERENCE TO RELATED APPLICATIONS

This application claims the benefit of U.S. Provisional Patent Application Serial No. 60/173,793, filed Dec. 30, 1999.

### TECHNICAL FIELD

The present invention is directed to hydrophobic metal particles, and the method of making such particles, that are useful as the magnetizable particles in magnetorheological fluids and magnetorheological elastomers. Hydrophilic metal particles, such as carbonyl iron particles, are made hydrophobic by reacting a surface hydroxyl on the solid metal particle with a reactive surfactant comprising at least one hydroxyl, carbonyl, or amine group and including at least one pendant hydrophobic alkyl group. Particles are coated with the reactive surfactant to cover at least about 90% of the surface of the particles and then washed with a low viscosity synthetic hydrocarbon to remove any excess surfactant. The coated particles are, thereby, stabilized against oxidation and irreversible coagulation during further processing, and formulation and use in magnetorheological fluids and elastomers.

### BACKGROUND OF THE INVENTION

Metallic particles suitable for use as the solid phase of magnetorheological (MR) fluids and elastomers are selected for their ability to perform as “soft” magnetizable materials. In the context of MR fluids and elastomers, this means that the solid metal particle can be magnetized to exhibit a high induced magnetic moment under a given magnetic field, but that the magnetic moment will relax, with little or no hysteresis, when the field is removed.

This magnetic property is primarily dependent upon the solid metallic particles selected for use and their chemistry and microstructure immediately prior to formulation into MR fluids and elastomers. Proper selection of suitable metallic particles and careful handling of those particles prior to formulation are therefore important in limiting the impact of processing and environmental conditions on the particles.

Metallic particles typically used in MR fluids and elastomers include carbonyl irons and iron alloys. The particles are usually formed by water or gas atomization. The particles, as powders, are stored under atmospheric conditions until use.

For safety and economic reasons, it is not practical to maintain the metal powders under inert atmospheres. Accordingly, most metal powders used in MR fluids and elastomers are oxidized to some degree prior to formulation. Furthermore, due to the finely divided character of the powders, oxidation tends to affect a large surface area. The practical effect of this oxidation is to change the surface chemistry of the metallic particles and degrade their saturation magnetization. This, in turn, impacts upon the strength and quality of the magnetic moment that can be created in a given MR fluid or elastomer under a magnetic field.

With pure iron particles, for example, oxidation results in the formation of its common oxide forms, FeO, Fe₂O₃, and Fe₃O₄. While pure iron particles have high permeability and saturation magnetization, the oxidized forms in comparison exhibit reduced magnetic properties.

Currently available MR fluids are formulated by dispersing magnetizable metallic particles in a hydrocarbon carrier fluid. To the carrier fluid may be added anti-settling, anti-friction and anti-wear components. A surfactant may also be added to the carrier fluid following dispersion of the metallic powder for “in situ” surface treatment of the iron particles. In order to assure a desirable high (i.e., 90% or greater) surface coverage of the surfactant on the metallic particles in the mixture, a large excess of the surfactant must be added. Since it is usually impractical, if not impossible, to remove the excess surfactant, it remains in the mixture.

Excess surfactant, however, is known to counteract the effect of thixotropes, such as fumed silica, used to stabilize MR fluids against particle settling. While it is recognized that a certain amount of surfactant is beneficial in promoting particle dispersion, excess surfactant that does not coat particles remains free in the mixture, counteracting the action of the thixotrope and thereby working to de-stabilize the mixture. Limiting the added surfactant to the minimum necessary to coat the particles is therefore desirable.

### SUMMARY OF THE INVENTION

By the present invention, it has been determined that surface-treating the metallic particles prior to formulation into MR fluids and elastomers substantially improves the performance of the fluids and elastomers. Early surface treatment according to the present invention limits oxidation of the particles and has the added advantage of reducing the necessity for special handling of the metallic powders that usually pose an explosive risk. Furthermore, particles treated according to the present invention exhibit satisfactory dispersion properties such that no addition of surfactant to the MR fluid mixture is required. Accordingly, MR fluids and elastomers prepared using the coated particles of the invention exhibit superior stability.

According to the present invention, hydrophilic metallic particles, such as carbonyl iron particles, are made hydrophobic by anchoring a surfactant molecule to the metal particle surface via a condensation reaction in which water is produced. Surface hydroxyls on the metallic particles react with a reactive surfactant that comprises at least one hydroxyl, carbonyl, or amine group and includes at least one pendant hydrophobic alkyl group. The particles are coated with the reactive surfactant to cover at least about 90% of the surface of the particles and then washed with a low viscosity synthetic hydrocarbon to remove any excess surfactant. The coated particles may be further processed by filtering, washing and drying to remove any residual free surfactant. The coated particles are, thereby, stabilized against oxidation and irreversible coagulation during further processing, and formulation and use in magnetorheological fluids and elastomers.

The effect of surface treatment, according to the present invention, in retarding oxidation is illustrated in FIG. 1. The steeper curve shows the weight gain of an “untreated” sample of an iron micropowder due to formation of oxidation products in a controlled heating rate thermogravimetric analysis (TGA) test. The “untreated” sample is carbonyl iron with a mean diameter of about 8 microns. In its virgin state, each particle has a thin oxide layer which forms in normal processing. It does not have any passivating effect, so that in an oxygen atmosphere the particles oxidize at a rate dictated solely by the temperature, the specific surface area, and the oxidation potential of the iron itself. A sample of the same type of carbonyl iron “treated” according to the present invention with a 90% surface coverage of ethoxylated tallow amine surfactant (Ethomeen T-15, from Akzo-Nobel) is shown in FIG. 1 by the shallower curve.

The ratio of oxidation rates for “untreated”/“treated” carbonyl iron is shown as a function of temperature in FIG. 2. As shown, the oxidation rate of untreated carbonyl iron is about 15 times higher than the same treated material for typical maximum fluid surface temperatures found in MR fluid shock absorbers (i.e., about 100° to about 110° C.) and about 2 to 5 times higher for typical MR fluid clutch applications under high torque conditions where the clutch is in the slip mode (i.e., temperatures of about 200° to 250° C.).

Following surfactant coating, metallic particles are washed to remove substantially all unreacted surfactant. It has been determined that when thixotropes such as fumed silica are used, it is important that the amount of free surfactant in a MR fluid be less than about 10% of the weight of the fumed silica. By the present invention, the particles are washed sufficiently to remove the unreacted surfactant from the particles.

It is further contemplated that the washing media is generally a low viscosity hydrocarbon which is the same or chemically compatible to the carrier fluid to be used in the MR fluid or elastomer. In this way, substantially all excess surfactant can be washed away, and any residual liquid entrained within the particles can be replaced with the carrier fluid or a carrier fluid-like material.

According to the present invention, surfactant-coated metallic particles are provided that are, (1) hydrophobic in order to enhance their dispersibility and stability in hydrocarbon carrier fluids used in MR fluids and elastomers, (2) surface-coated to at least about 90% of their surface area to substantially inhibit oxidation and magnetic degradation of the metal powders, and (3) substantially free of unreacted surfactant.

The thus coated particles may be filtered, further washed and dried to remove additional trace contaminants. As treated, the particles are stabilized against oxidation and irreversible coagulation during further processing, and formulation and use in MR fluids and elastomers. When treatment occurs well in advance of formulation into MR compositions, the hydrophobic metallic particles of the present invention have the added advantage of being safer and more cost efficient to handle and use due to the reduced risk of explosion and need for special handling of the fine metallic powders.

By the present invention, MR fluids and elastomers may now be prepared that are stabilized against particle oxidation and magnetic degradation typical of currently available MR compositions, and during use will be subject to substantially lower oxidation and magnetic degradation. By using the hydrophobic metal powders of the present invention, MR fluids and elastomers may be prepared that include the present hydrophobic metal powders, known hydrocarbon carrier fluids such as polyalphaolefin, known thixotropes such as fumed silica, and known anti-friction and anti-wear additives, but without the further addition of surfactants.

### BRIEF DESCRIPTION OF THE DRAWINGS

FIG. 1 shows the difference in the oxidation for samples treated according to the present invention and untreated samples.

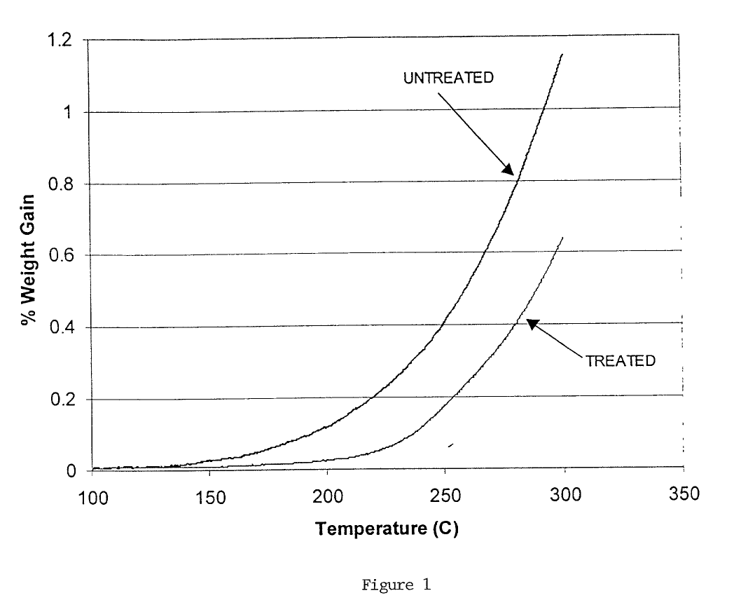

FIG. 2 shows the ratio of the rate of oxidation of the untreated to treated samples of FIG. 1.

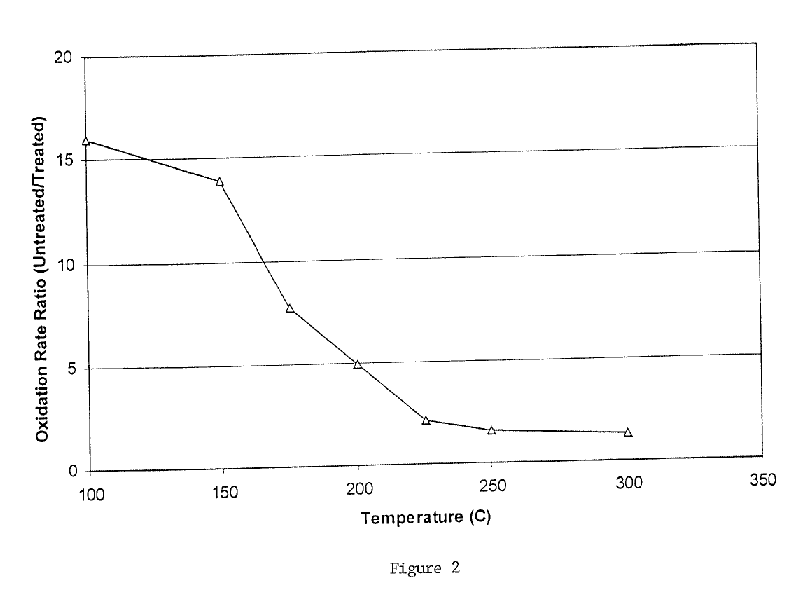

FIG. 3 shows the adsorption isotherm for a sample treated according to the present invention with a tallow amine surfactant.

### DESCRIPTION OF THE PREFERRED EMBODIMENT

In the present invention, surfactants selected from ethoxylated amines and fatty acids are preferred with ethoxylated amines being most preferred. Ethoxylated amines having the following chemical structure are preferred:

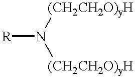

where R is an alkyl group, and the sum of x+y range from 2 to 50. An example of a suitable commercially available ethoxylated amine is Ethomeen T-15 available from Akzo Nobel. For Ethomeen T-15, x+y=5, and R is a mixture of alkyl groups, approximately half of which contain some unsaturation. The alkyl groups can be saturated, derived from, for example, octadecanoic acid (e.g., Ethomeen 18/15, from Akzo Nobel). Propoxylated amines, such as N-tallowalkyl-1,1′-iminobis-2-propanol (e.g., Propomeen T/12, from Akzo Nobel) and ethoxylated diamines, such as ethoxylated (3) N-tallow-1,3-daiminopropane (e.g., Ethoduomeen T/13, from Akzo Nobel) are also suitable and are available commercially. Fatty acid surfactants that may be used include, for example, oleic acid, linoleic acid, palmitic acid, and the like.

The concentration of surfactant used may be determined by evaluation of the adsorption isotherm for the selected surfactant and metallic particle or by other methods known to those of skill in the art. In the present invention, the adsorption isotherm was identified to determine the surfactant concentration necessary to achieve at least about 90% coverage.

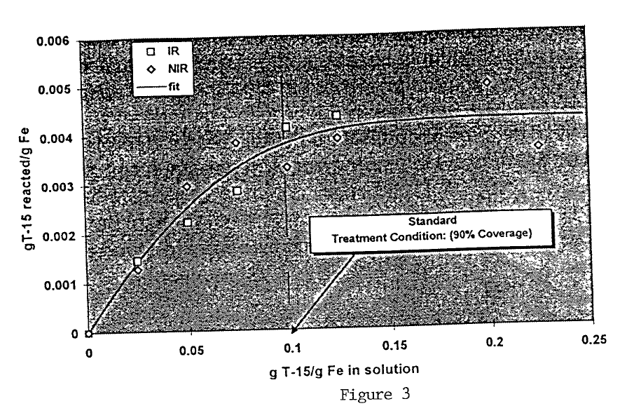

FIG. 3 is exemplary of such an adsorption isotherm for ethoxylated (5) tallow alkyl Ethomeen T-15 (from Akzo Nobel) used to treat carbonyl iron powder. As is the case with any such process, there is a partition of the surfactant between the solution and the liquid/metal powder interface. Infrared and/or near infrared spectroscopy was used to follow the change in solution concentration of the surfactant used to treat the metallic particle. A plot of the mass of T-15 reacted per unit mass of iron powder versus the mass of T-15 in solution (expressed as mass T-15/mass Fe in solution) gives the “adsorption isotherm.” Referring to FIG. 3, the plateau concentration represents maximum surface coverage with a 10% solution of the surfactant (i.e., 10 g T-15/100 g carbonyl Fe) producing about 90% maximum coverage.

It will be recognized that treatment times for different combinations of particles and surfactant may vary, but are readily discernable by those of skill in the art to achieve a surface coverage of at least about 90%. Since the mechanism of adsorption as used in the present invention involves a condensation reaction in which water is produced, appropriate reaction times can be determined by monitoring water content in the post-treatment liquid by known techniques including, for example, near infrared (NIR) analysis. Reaction completion time may thus be inferred by determining when no additional water is being produced.

It has been determined that the treatment temperature should be at or near ambient temperatures. Tests using carbonyl iron CM (from BASF Corp.) were conducted at a temperatures of about 25° C. for 24 hours and at 40° C. for 4, 8, and 24 hours. Since water is generated in the treatment reaction, the extent of treatment was inferred from NIR analysis of the water content of the post-treatment liquid. The result showed that the extent of treatment decreased at higher temperature.

In general terms, particles of the present invention are preferably treated with surfactant at an ambient temperature in the range of about 20° C. to about 30° C. for a period of greater than about 6 hours, and more preferably treated at a temperature of about 23° C. to about 27° C. for 8 to 12 hours.

The washing media may be selected from a low viscosity synthetic hydrocarbon or a chemically equivalent substance. In the present invention, the preferred washing media is a low viscosity synthetic hydrocarbon such as a polyalphaolefin (PAO) based on 1-decene or 1-dodecene, examples of which include: SHF 21 (available from Mobil Corp.), which is primarily the dimer of 1-decene, SHF 41 (also available from Mobil), which is a mixture of trimer and tetramer of 1-decene, and the dimer of 1-dodecene (available from Chevron Corp.). In each case, the chemical nature of the liquid promotes surfactant solubility, and the low viscosity allows efficient post-treatment wash to remove excess surfactant.

The amount of washing media used should be sufficient to remove at least 90% of all unreacted surfactant from the treated particles, preferably greater than about 95% and most preferably greater than about 98%.

Tests were conducted using a 1300-gram sample of carbonyl iron coated with Ethomeen T-15 for use in a MR fluid containing fumed silica. Results showed that the sample was effectively washed via two washings of 300 grams (each wash) of PAO reducing the level of Ethomeen T-15 in the residual liquid to less than about 2%. This reduction would ensure that that weight percent of T-15 would be less than 10% of the weight of the fumed silica used in the MR fluid.

A metallic particle of the present invention is prepared by anchoring a surfactant molecule to the particle surface via a condensation reaction in which water is produced. Particles are treated in a manner to achieve surface coverage of at least about 90%. Following surface treatment, the treated metal particles are washed with the washing medium to the extent necessary to sufficiently to remove the excess, unreacted surfactant. Treated particles according to the present invention may be further processed by filtering, washing, and drying.

Hydrophobic metal particles of the present invention may be formulated into MR fluids and elastomers by mixing the particles with a hydrocarbon carrier fluid such as a polyalphaolefin, a thixotrope such as fumed silica, and known anti-wear and anti-friction components. No further surfactant addition is required. MR fluids and elastomers prepared with hydrophobic metal powders and particles of the present invention are stabilized against particle oxidation and magnetic degradation, and provide superior stability due to the lack of excess unreacted surfactant in the MR composition.

While the preferred embodiment of the present invention has been described so as to enable one skilled in the art to practice hydrophobic metallic particles suitable for use in magnetorheological fluids and elastomers, it is to be understood that variations and modifications may be employed without departing from the concept and intent of the present invention as defined by the following claims. The preceding description is intended to be exemplary and should not be used to limit the scope of the invention. The scope of the invention should be determined only by reference to the following claims.

What is claimed is:

1. A hydrophobic metal powder for use in magnetorheological fluids and magnetorheological elastomers comprising a plurality of solid metal particles selected from iron or iron alloys and a surfactant comprising at least one hydroxyl, carbonyl, or amine group and including at least one pendant hydrophobic alkyl group adsorbed to at least about 90% of the surface area of said metal particles.

2. A metal powder of claim 1 wherein said solid metal particles are carbonyl iron.

3. A metal powder of claim 1 wherein said surfactant is selected from ethoxylated amines, propoxylated amines and mixtures thereof.

4. An ethoxylated amine of claim 3 having the chemical structure, 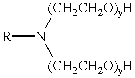
where R is an alkyl group, and the sum of x+y ranges from 2 to 50.

5. An ethoxylated amine of claim 4 wherein R is a mixture of saturated and unsaturated alkyl groups and x+y=5.

6. A magnetorheological composition of a fluid or elastomer comprising,
a. a hydrophobic carbonyl iron powder comprising a plurality of particles having an ethoxylated amine surfactant adsorbed to at least about 90% of the surface area of said particles,
b. a polyalphaolefin carrier fluid, and
c. a fumed silica thixotrope,
wherein the amount of said non-adsorbed surfactant in the magnetorheological composition is less than about 2% by weight of said composition.

7. A magnetorheological composition of claim 6 wherein said non-absorbed surfactant in said composition is less than about 10% by weight of said fumed silica.

8. A process for producing hydrophobic metal particles for use in magnetorheological fluids and magnetorheological elastomers comprising, treating hydrophilic solid metal particles of iron or iron alloys having surface hydroxyl groups with a surfactant comprising at least one hydroxyl, carbonyl, or amine group and including at least one pendant hydrophobic alkyl group until said surfactant has been adsorbed onto at least about 90% of the surface area of said particles, and washing at least about 95% by weight of the unreacted surfactant from said particles using a low viscosity synthetic hydrocarbon.

9. A process of claim 8 wherein said particles are carbonyl iron.

10. A process of claim 8 wherein said surfactant is selected from ethoxylated amines, propoxylated amines and mixtures thereof.

11. A process of claim 10 wherein the ethoxylated amine has the chemical structure, 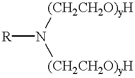
where R is an alkyl group, and the sum of x+y ranges from 2 to 50.

12. A process of claim 11 wherein R is a mixture of saturated and unsaturated alkyl groups and x+y=5.

13. A process of claim 12 wherein washing of said particles removes at least about 98% by weight of said unreacted surfactant and wherein said low viscosity synthetic hydrocarbon is a polyalphaolefin.

14. A process of claim 13 wherein said polyalphaolefin is based on 1-decene or 1-dodecene.

15. A process of claim 8 further comprising filtering, additional washing and drying of said particles.
